(19) United States
(12) Patent Application Publication
(10) Pub. No.: US 2012/0190542 A1
(43) Pub. Date: Jul. 26, 2012

(54) FUNGICIDAL MIXTURES AND THEIR USE

(75) Inventors: Patrick John Doyle, Guelph (CA); Gilberto Olaya-Huertas, Vero Beach, FL (US); Paul John Kuhn, Vero Beach, FL (US); Allison Tally, Greensboro, NC (US)

(73) Assignee: SYNGENTA CROP PROTECTION, LLC, Greensboro, NC (US)

(21) Appl. No.: 13/264,722

(22) PCT Filed: Mar. 29, 2010
(86) PCT No.: PCT/EP2010/054065

§ 371 Date: Apr. 11, 2012

(30) Foreign Application Priority Data
Apr. 15, 2009 (GB) 0906515.2

(51) Int. Cl. A01C 1/06; A01P 3/00; A01N 43/90; A01N 43/54; A01P 7/04; A01N 59/16; A01N 43/707; A01P 21/00; A01P 1/00; A01N 43/40; A01N 59/20

(52) U.S. Cl. 504/100; 514/357; 514/259.31; 514/269; 424/638; 424/618; 514/352; 514/355; 514/242; 504/358

(57) ABSTRACT

The present invention relates to pesticidal mixtures, compositions and uses thereof comprising a component (A) and a component (B), wherein components (A) and (B) are: (A) a carboxylic acid amide fungicide; and (B) a benzamide fungicide; with the proviso that the mixture does not comprise: 1). fluopicolide and mandipropamid and clothianidin; or 2). fluopicolide and mandipropamid and imidacloprid; or 3). fluopicolide and mandipropamid and thiamethoxam. The invention also relates to mixtures, compositions and uses thereof wherein component (A) is metalaxyl-M and component (B) is a benzamide fungicide.

The present invention relates to mixtures and compositions for protecting crop plants against phytopathogenic diseases, for treating crop plants infected with phytopatho-genic diseases, and to methods of protecting crop plants against phytopathogenic diseases.

Fungicidal mixtures of particular carboxylic acid amide derivatives such as mandipropamid with other fungicides are known e.g. from EP-A-610764, WO 01/44215, WO 01/87822, and WO2004/049804. Mandipropamid has the chemical structure shown in formula (I):

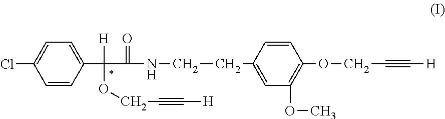

Fluopicolide is a pyridylmethylbenzamide derivative disclosed in WO 99/42447 and is known to have fungicidal activity. WO 2008/077924 discloses mixtures of fluopicolide with insecticides. Fluopicolide has the chemical structure shown in formula (II):

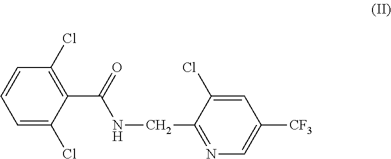

Various fungicidal compounds of different chemical classes are widely known as plant fungicides for application in various crops of cultivated plants. However, there is a continuing need for new fungicides that show a broader range of activity, that address fungicide resistance and that can be applied at lower rates, thereby minimizing the amount of pesticides released into the environment.

The present invention seeks to address these needs by providing novel mixtures and compositions for control of diseases caused by phytopathogenic fungi. In a broad aspect the invention provides mixtures and compositions comprising a carboxylic acid amide fungicide and a benzamide fungicide, in particular mandipropamid and fluopicolide, as well as mixtures and compositions comprising metalaxyl-M and a benzmide fungicide, in particular metalaxyl-M and fluopicolide.

In a first aspect of the invention there is provided a pesticidal mixture comprising a component (A) and a component (B), wherein components (A) and (B) are:
(A) a carboxylic acid amide fungicide; and
(B) a benzamide fungicide;
   with the proviso that the composition does not comprise:
1. fluopicolide and mandipropamid and clothianidin; or
2. fluopicolide and mandipropamid and imidacloprid; or
3. fluopicolide and mandipropamid and thiamethoxam.

In a further aspect of the invention there is provided a composition for controlling fungal diseases caused by phytopathogens comprising
(A) a carboxylic acid amide fungicide; and
(B) a benzamide fungicide;
   with the proviso that the composition does not comprise:
1. fluopicolide and mandipropamid and clothianidin; or
2. fluopicolide and mandipropamid and imidacloprid; or
3. fluopicolide and mandipropamid and thiamethoxam.

In one embodiment the mixtures and compositions of the invention may not comprise an insecticide.

Component (A) may be selected from the group consisting of:

an N-alkoxycarbonyl-alpha-amino acid amide derivative of formula III, or an optical isomer thereof

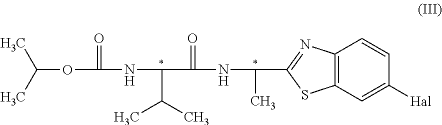

in which Hal is fluoro, chloro or bromo;
an N-alkylsulfonyl-alpha-amino acid amide derivative of formula IV, or an optical isomer thereof

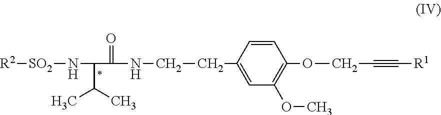

in which R¹ is hydrogen, C₁₋C₄alkyl, C₃₋C₆cycloalkyl or halophenyl; and R² is C₁₋C₄alkyl;
an alpha-alkynyloxyphenylacetic acid amide derivative of formula V, or an optical isomer thereof

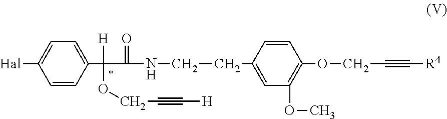

in which Hal is fluoro, chloro or bromo; R³ is hydrogen, C₁₋C₄alkyl or halophenyl; and
R⁴ is hydrogen, C₁₋C₄alkyl, C₃₋C₆cycloalkyl or halophenyl;
dimethomorph;
flumorph;
benthiavalicarb;
iprovalicarb; and
valifenalate.

Component (A) may be selected from the group consisting of:

a compound of formula III in which Hal is fluoro or chloro;
a compound of formula IV in which R¹ is hydrogen, fluorophenyl or chlorophenyl; and R² is methyl or ethyl;
a compound of formula V in which Hal is chloro or bromo; R³ is hydrogen or methyl; and R⁴ is hydrogen or methyl;
dimethomorph;
flumorph;
benthiavalicarb;
iprovalicarb; and
valifenalate.

Component (A) may be selected from the group consisting of:

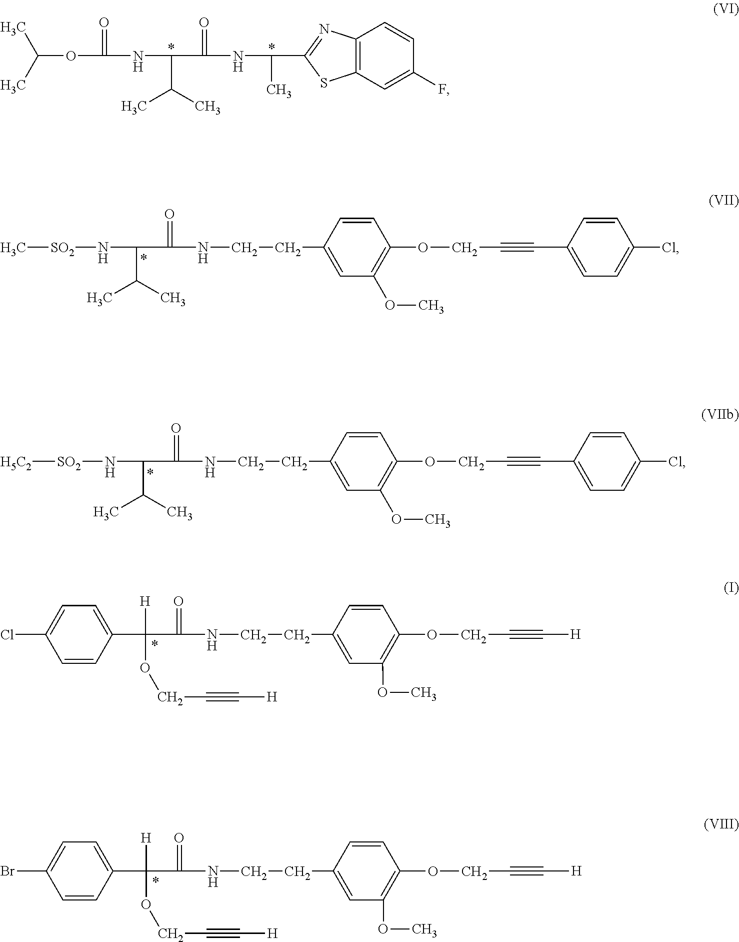

dimethomorph;
flumorph;
benthiavalicarb;
iprovalicarb; and
valifenalate.

Component (A) may be selected from the group consisting of:

mandipropamid;
dimethomorph;
flumorph;
benthiavalicarb;
iprovalicarb; and
valifenalate.

Component (B) may be selected from the group consisting of a compound of formula

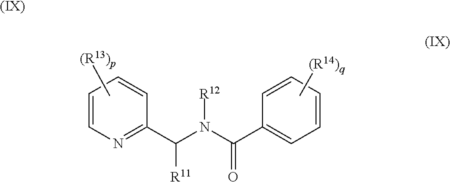

wherein:
R¹¹ may be a hydrogen atom, a C₁-C₄ alkyl group or C₂-C₄ acyl group;
R¹² may be a hydrogen atom or a C₁-C₄ alkyl group;
R¹³ and R¹⁴ may be, independently, a halogen atom, a hydroxyl group, a cyano group, a nitro group, —SF₅, a trialkylsilyl group, an amino group, a C₂-C₄ acyl group, phenyl, or a group E, OE or SE, in which E may be an C₁-C₄ alkyl, C₂-C₄ alkenyl, C₂-C₄ alkynyl, C₃-C₆ cycloalkyl, C₃-C₆ cycloalkenyl in which each alkyl, alkenyl, alkynyl, cycloalkyl, cycloalkenyl or phenyl may be optionally substituted by halogen;
p represents 0, 1, 2, 3 or 4;
q represents 0, 1, 2, 3 or 4;
and zoxamide.
Component B may be selected from the group consisting of a compound of formula (X)

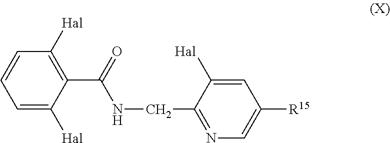

in which Hal is fluoro, chloro or bromo, R¹⁵ is CH₂F, CF₂ or CF₃; and
zoxamide.

The mixtures and compositions of the invention may comprise components (A) and (B) in which component (A) is selected from the group consisting of

mandipropamid;
dimethomorph;
flumorph;
benthiavalicarb;
iprovalicarb; and
valifenalate; and component (B) is fluopicolide.

The mixtures and compositions of the invention may comprise components (A) and (B) in which component (A) is mandipropamid and component (B) is fluopicolide.

In a further aspect the invention provides a composition comprising as active ingredients

(A) mandipropamid,
(B) fluopicolide, and optionally
(C) an active ingredient selected from the group consisting of a fungicide, an insecticide, a bactericide and a plant bioregulator, wherein the insecticide is not thiamethoxam, imidacloprid or clothianidin;
and customary formulation ingredients.

In a further aspect the invention provides a composition comprising as active ingredients

(A) mandipropamid,
(B) fluopicolide, and optionally
(C) an active ingredient selected from the group consisting of
a fungicide selected from mancozeb, chlorothalonil, metalaxyl-M, metalaxyl, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil;
a bactericide selected from oxidised copper and oxidised silver; and acibenzolar-S-methyl;
and customary formulation ingredients.

In a further aspect the invention provides a composition consisting of

(A) mandipropamid,
(B) fluopicolide, and optionally
(C) an active ingredient selected from the group consisting of a fungicide, an insecticide, a bactericide and a plant bioregulator, wherein the insecticide is not thiamethoxam, imidacloprid or clothianidin;
and customary formulation ingredients.

In a further aspect the invention provides a composition consisting of

(A) mandipropamid,
(B) fluopicolide, and optionally
(C) an active ingredient selected from the group consisting of
a fungicide selected from mancozeb, chlorothalonil, metalaxyl-M, metalaxyl, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil;
a bactericide selected from oxidised copper and oxidised silver; and acibenzolar-S-methyl;
and customary formulation ingredients.

The composition may comprise, as active ingredients, mandipropamid and fluopicolide, and customary formulation ingredients. The composition may consist of mandipropamid and metalaxyl-M and customary formulation ingredients.

The invention also provides a pesticidal mixture comprising a component (A) and a component (B), wherein components (A) and (B) are:
(A) metalaxyl-M; and
(B) a benzamide fungicide;
   with the proviso that the mixture does not comprise:
1. fluopicolide and metalaxyl-M and clothianidin; or
2. fluopicolide and metalaxyl-M and imidacloprid; or
3. fluopicolide and metalaxyl-M and thiamethoxam.

In a further aspect the invention provides a composition for controlling fungal diseases caused by phytopathogens comprising
(A) metalaxyl-M; and
(B) a benzamide fungicide.
   with the proviso that the composition does not comprise:
1. fluopicolide and metalaxyl-M and clothianidin; or
2. fluopicolide and metalaxyl-M and imidacloprid; or
3. fluopicolide and metalaxyl-M and thiamethoxam.

Component (B) may be a benzamide fungicide as described above but is preferably fluopicolide.

Metalaxyl-M is a stereoisomer and has the formula:

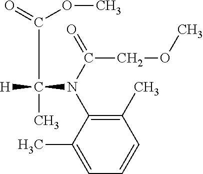

Metalaxyl is a racemic mixture of metalaxyl-M and the alternative stereoisomer. Metalaxyl-M is therefore not the same as metalaxyl. This means, for example, that the mixtures and compositions of the invention are substantially free of the alternative stereoisomer of metalaxyl-M, e.g. the mixture or composition of the invention does not contain the alternative stereoisomer of metalaxyl-M.

In a further aspect, the invention provides a composition comprising as active ingredients

(A) metalaxyl-M,
(B) fluopicolide, and optionally
(C) an active ingredient selected from the group consisting of a fungicide, an insecticide, a bactericide and a plant-bioregulator, wherein the insecticide is not thiamethoxam, clothianidin or imidacloprid; and customary formulation ingredients.

In a further aspect, the invention provides a composition comprising as active ingredients

(A) metalaxyl-M,
(B) fluopicolide and optionally
(C) an active ingredient selected from the group consisting of
a fungicide selected from mancozeb, chlorothalonil, mandipropamid, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil; a bactericide selected from oxidised copper and oxidised silver; and acibenzolar-S-methyl;
and customary formulation ingredients.

In a further aspect the invention provides a composition consisting of

(A) metalaxyl-M,
(B) fluopicolide, and optionally
(C) an active ingredient selected from the group consisting of a fungicide, an insecticide, a bactericide and a plant-bioregulator, wherein the insecticide is not thiamethoxam, clothianidin or imidacloprid; and customary formulation ingredients.

In a further aspect the invention provides a composition consisting of

(A) metalaxyl-M,
(B) fluopicolide and optionally
(C) an active ingredient selected from the group consisting of
a fungicide selected from mancozeb, chlorothalonil, mandipropamid, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil;
a bactericide selected from oxidised copper and oxidised silver; and acibenzolar-S-methyl;
and customary formulation ingredients.

The composition may comprise, as active ingredient metalaxyl-M and fluopicolide, and customary formulation ingredients. The composition may consist of metalaxyl-M, fluopicolide and customary formulation ingredients.

Combinations comprising metalaxyl-M and fluopicolide are particularly suitable for seed treatment applications. Accordingly, the present invention provides a method of controlling diseases on propagation material caused by phytophathogens e.g. pythium and/or various oomycete pathogens, comprising applying a mixture or composition of the invention to the plant propagation material. Of particular interest are seeds of corn, soybean, wheat, barley, cotton and canola.

The mixtures and compositions may comprise a combination of components (A) and (B), e.g. a fungicidally effective combination of components together with an agriculturally acceptable carrier, and optionally a surfactant.

In a further aspect of the invention there is provided is a method of controlling diseases on useful plants or on propagation material thereof caused by phytopathogens, which comprises applying to the useful plants, the locus thereof or propagation material thereof a mixture or composition according to the invention. Preferred is a method, which comprises applying to the useful plants or to the locus thereof a mixture or composition according to the invention, more preferably to the useful plants. Further preferred is a method, which comprises applying to the propagation material of the useful plants a mixture or composition according to the invention.

The present invention also includes pesticidal mixtures comprising a component (A) and a component (B) in a synergistically effective amount; agricultural compositions comprising a mixture of component (A) and (B) in a synergistically effective amount; the use of a mixture of component (A) and (B) in a synergistically effective amount for combating phytopathogenic fungi; a method for protecting crops from attack or infestation by phythopathogenic fungi, which comprises contacting a crop with a mixture of component (A) and (B) in a synergistically effective amount; a method for the protection of seeds and/or of the seedlings' roots and shoots from phythopathogenic fungi comprising contacting the seeds before sowing and/or after pre-germination with a mixture of component (A) and (B) in a synergistically effective amount; seeds comprising, e.g. coated with, a mixture of component (A) and (B) in a synergistically effective amount; a method comprising coating a seed with a mixture of component (A) and (B) in a synergistically effective amount; a method of controlling phytopathogenic, e.g. fungal, diseases on useful plants or on propagation material thereof, which comprises applying to the useful plants, the locus thereof or propagation material thereof a combination of components (A) and (B) in a synergistically effective amount. In such applications the mixtures of (A) and (B) will normally be applied in a fungicidally effective amount. In application components (A) and (B) may be applied simultaneously or separately.

Depending upon the number of carbon atoms, alkyl on its own or as part of another substituent is to be understood as being, for example, methyl, ethyl, propyl, butyl and the isomers thereof, for example isopropyl, isobutyl, tert-butyl or sec-butyl. The terms alkenyl and alkynyl are to be similarly understood.

Depending upon the number of carbon atoms, cycloalkyl on its own or as part of another substituent is to be understood as being, for example, cyclopropyl, cyclobutyl, cyclopentyl or cyclohexyl.

A halophenyl group may contain one or more (identical or different) halogen atoms, and for example may stand for fluorophenyl, chlorophenyl, bromophenyl or iodophenyl, being optionally further substituted with preferably one or two fluoro, chloro or bromo radicals. Examples include 2-fluorophenyl, 3-fluorophenyl, 4-fluorophenyl, 2-chlorophenyl, 3-chlorophenyl, 4-chlorophenyl, 2-bromophenyl, 3-bromophenyl, 4-bromophenyl, 2,4-difluorophenyl, 3,4-difluorophenyl, 2-chloro-4-fluorophenyl, 2,4-dichlorophenyl, 3,4-dichlorophenyl, 2-fluoro-4-chlorophenyl, 2-bromo-4-fluoro-phenyl, 3-bromo-4-fluorophenyl, 4-bromo-2-fluoro-phenyl, 2,5-difluorophenyl, 3,5-difluorophenyl, 2,6-dichloro-4-fluorophenyl, 2,5-chlorophenyl, 3,5-chlorophenyl, 3,4,5-trichlorophenyl, 2-bromo-4,5-dichlorophenyl, 5-bromo-2,4-dichlorophenyl and 4-bromo-2,6-dichlorophenyl.

The presence of at least one asymmetric carbon atom in a compound (denoted by *) means that the compounds may occur in optically isomeric and enantiomeric forms. Additionally, as a result of the presence of a possible steric hindrance of free rotation around an aliphatic carbon-carbon single bond geometric isomerism may also occur. For the avoidance of doubt, the invention extends to all possible enantiomeric and geometric isomeric forms in all compounds that may be included in the compositions of the invention. Reference herein to any particular compound refers to the tautomeric forms and salts where possible.

Preferred subgroups of compounds of formula III, IV and V are those wherein

Hal is fluoro, chloro or bromo, or
Hal is fluoro or chloro; or
Hal is chloro;
R¹ is hydrogen or halophenyl; or
R¹ is hydrogen, fluorophenyl or chlorophenyl; or
R¹ is chlorophenyl;
R² is C₁₋C₃alkyl; or
R² is methyl or ethyl; or
R² is methyl;
R³ is hydrogen or C₁₋C₃alkyl; or
R³ is hydrogen or methyl; or
R³ is hydrogen;
R⁴ is hydrogen or C₁₋C₃alkyl; or
R⁴ is hydrogen or methyl; or
R⁴ is hydrogen; or

For example, Hal is fluoro, chloro or bromo, R¹ is hydrogen or halophenyl, R² is C₁₋C₃alkyl, R³ is hydrogen or C₁₋C₃alkyl, and R⁴ is hydrogen or C₁₋C₃alkyl; or

R¹ is hydrogen, fluorophenyl or chlorophenyl, R² is methyl or ethyl, Hal is chloro or bromo, R³ is hydrogen or methyl, and R⁴ is hydrogen or methyl; or
R¹ is chlorophenyl, R² is methyl or ethyl, and R³ and R⁴ are hydrogen.

Preferred subgroups of compounds of formula (IX) are those wherein:

R¹¹ is a hydrogen atom or a C₁-C₄ alkyl group; or
R¹¹ is a hydrogen atom or methyl group; or
R¹¹ is a hydrogen atom;
R¹² is a hydrogen atom or methyl group; or
R¹² is a hydrogen atom;

Each R¹³ is, independently, a halogen atom, a hydroxyl group, a cyano group, a nitro group, an amino group, an alkyl group or a haloalkyl group; or

each R¹³ is, independently, a halogen atom or a haloalkyl group; or
each R¹³ is, independently, a halogen atom or a trihalomethyl group;

Each R¹⁴ is, independently, a halogen atom, a hydroxyl group, a cyano group, a nitro group, an amino group, an alkyl group or a haloalkyl group; or

each R¹⁴ is, independently, a halogen atom or a haloalkyl group; or
each R¹⁴ is, independently, a halogen atom or a trihalomethyl group;
p is 0, 1, or 2; or
p is 2;
q is 0, 1, or 2; or
q is 2.

For example, R¹¹ is a hydrogen atom or a C₁-C₄ alkyl group, R¹² is a hydrogen atom or methyl group, each R¹³ is, independently, a halogen atom, a hydroxyl group, a cyano group, a nitro group, an amino group, an alkyl group or a haloalkyl group, each R¹⁴ is, independently, a halogen atom, a hydroxyl group, a cyano group, a nitro group, an amino group, an alkyl group or a haloalkyl group, p is 0, 1, or 2, and q is 0, 1, or 2; or

R¹¹ is a hydrogen atom or methyl group, R¹² is a hydrogen atom, each R¹³ is, independently, a halogen atom or a haloalkyl group, each R¹⁴ is, independently, a halogen atom or a haloalkyl group, p is 2, and q is 2; or
R¹¹ is a hydrogen atom, R¹² is a hydrogen atom, each R¹³ is, independently, a halogen atom or a trihalomethyl group, each R¹⁴ is, independently, a halogen atom or a trihalomethyl group, p is 2, and q is 2.

The compounds of formula III are known from EP-A-775696. The specific compound VI is disclosed as compound No. 4 in the same document. The compounds of formulae IV and V are known from WO 99/07674 and WO 01/87822. Compounds VII and VIIb are disclosed as compounds 1.003 and 1.035 in the earlier document, while compounds I and VIII are E1.011 and E1.025 in the latter.

Oxidised copper such as copper hydroxide is sold under the trade name Kocide®, Parasol®. Oxidised silver, such as oxysilver nitrate is sold under the trade name Agress® and is described for example in WO 2007/147267.

The compounds of formula (IX) are known from WO 2008/077924. Fluopicolide is disclosed in WO 99/42447.

The compounds of the invention are either commercially available or obtainable according to procedures analogous to those published in the respective patent documents or the literature cited therein.

According to the Fungicide Resistance Action Committee (FRAC) Code List 2009 the benzamide fungicides fluopicolide and zoxamide have a similar mode of action in that both affect mitosis and cell division. These are grouped in class B. Mandipropamid, dimethomorph, flumorph, benthiavalicarb, iprovalicarb and valifenalate also have a similar mode of action in that they each affect lipids and membrane synthesis, and are specifically proposed to affect phospholipid biosynthesis and cell wall deposition. These have been grouped into class F5.

Throughout this document the term “combination” stands for the various combinations of components (A) and (B), e.g. in a single “ready-mix” form, such as a ready-to-use formulation comprising the two active components in a fixed ratio; or in a combined spray mixture composed from separate formulations of the single active ingredient components, e.g. a “tank-mix”, or in a combined use of the single active ingredients when applied in common spray plan or schedule a sequential manner, i.e. one after the other with a reasonably short period, e.g. a few hours or days. When applied in separate sprays following each other, the order of applying the components (A) and (B) is not essential for achieving the biological results according to the present invention.

The mixtures and compositions according to the invention are effective especially against phytopathogenic fungi belonging to the following classes: Ascomycetes (e.g. Venturia, Podosphaera, Erysiphe, Monilinia, Mycosphaerella, Uncinula); Basidiomycetes (e.g. the genus Hemileia, Rhizoctonia, Phakopsora, Puccinia, Ustilago, Tilletia); Plasmodiophora; Fungi imperfecti (also known as Deuteromycetes; e.g. Botrytis, Helminthosporium, Rhynchosporium, Fusarium, Septoria, Cercospora, Alternaria, Pyricularia and Pseudocercosporella); Oomycetes (e.g. Phytophthora, Peronospora, Pseudoperonospora, Albugo, Bremia, Pythium, Pseudosclerospora, Plasmopara).

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or black-berries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. Turf and flowers are of particular interest This list does not represent any limitation.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names Genuity®, RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

In a further aspect, the invention provides seeds comprising a mixture or composition of the invention. In a further aspect, the invention provides a method comprising coating a seed with a mixture or composition of the invention.

The mixtures and compositions of the present invention may also be used in the field of protecting storage goods against attack of fungi. According to the present invention, the term “storage goods” is understood to denote natural substances of vegetable and/or animal origin and their processed forms, which have been taken from the natural life cycle and for which long-term protection is desired. Storage goods of vegetable origin, such as plants or parts thereof, for example stalks, leafs, tubers, seeds, fruits or grains, can be protected in the freshly harvested state or in processed form, such as pre-dried, moistened, comminuted, ground, pressed or roasted. Also falling under the definition of storage goods is timber, whether in the form of crude timber, such as construction timber, electricity pylons and barriers, or in the form of finished articles, such as furniture or objects made from wood. Storage goods of animal origin are hides, leather, furs, hairs and the like. The compositions according the present invention can prevent disadvantageous effects such as decay, discoloration or mold. Preferably “storage goods” is understood to denote natural substances of vegetable origin and/or their processed forms, more preferably fruits and their processed forms, such as pomes, stone fruits, soft fruits and citrus fruits and their processed forms. In another preferred embodiment of the invention “storage goods” is understood to denote wood.

Therefore a further aspect of the present invention is a method of protecting storage goods, which comprises applying to the storage goods a mixture or composition according to the invention.

The compositions of the present invention may also be used in the field of protecting technical material against attack of fungi. According to the present invention, the term “technical material” includes paper; carpets; constructions; cooling and heating systems; wall-boards; ventilation and air conditioning systems and the like; preferably “technical material” is understood to denote wall-boards. The compositions according the present invention can prevent disadvantageous effects such as decay, discoloration or mold.

The mixtures and compositions according to the invention are particularly effective against powdery mildews; rusts; leafspot species; early blights and molds; especially against Septoria, Puccinia, Erysiphe, Pyrenophora and Tapesia in cereals; Phakopsora in soybeans; Hemileia in coffee; Phragmidium in roses; Alternaria in potatoes, tomatoes and cucurbits; Sclerotinia in turf, vegetables, sunflower and oil seed rape; black rot, red fire, powdery mildew, grey mold and dead arm disease in vine; Botrytis cinerea in fruits; Monilinia spp. in fruits and Penicillium spp. in fruits.

The mixtures and compositions according to the invention are furthermore particularly effective against seed borne and soilborne diseases, such as Alternaria spp., Ascochyta spp., Botrytis cinerea, Cercospora spp., Claviceps purpurea, Cochliobolus sativus, Colletotrichum spp., Epicoccum spp., Fusarium graminearum, Fusarium moniliforme, Fusarium oxysporum, Fusarium proliferatum, Fusarium solani, Fusarium subglutinans, Gaumannomyces graminis, Helminthosporium spp., Microdochium nivale, Phoma spp., Pyrenophora graminea, Pyricularia oryzae, Rhizoctonia solani, Rhizoctonia cerealis, Sclerotinia spp., Septoria spp., Sphacelotheca reilliana, Tilletia spp., Typhula incarnata, Urocystis occulta, Ustilago spp. or Verticillium spp.; in particular against pathogens of cereals, such as wheat, barley, rye or oats; maize; rice; cotton; soybean; turf; sugarbeet; oil seed rape; potatoes; pulse crops, such as peas, lentils or chickpea; and sunflower.

The mixtures and compositions according to the invention are furthermore particularly effective against post harvest diseases such as Botrytis cinerea, Colletotrichum musae, Curvularia lunata, Fusarium semitecum, Geotrichum candidum, Monilinia fructicola, Monilinia fructigena, Monilinia laxa, Mucor piriformis, Penicilium italicum, Penicilium solitum, Penicillium digitatum or Penicillium expansum in particular against pathogens of fruits, such as pome fruits, for example apples and pears, stone fruits, for example peaches and plums, citrus, melons, papaya, kiwi, mango, berries, for example strawberries, avocados, pomegranates and bananas, and nuts.

The mixtures and compositions according to the invention are particularly useful for controlling the following diseases on the following crops:

Alternaria species in fruit and vegetables; Ascochyta species in pulse crops; Botrytis cinerea in strawberries, tomatoes, sunflower, pulse crops, vegetables and grapes, such as Botrytis cinerea on grape; Cercospora arachidicola in peanuts; Cochliobolus sativus in cereals;

Colletotrichum species in pulse crops; Erysiphe species in cereals; such as Erysiphe graminis on wheat and Erysiphe graminis on barley; Erysiphe cichoracearum and Sphaerotheca fuliginea in cucurbits; Fusarium species in cereals and maize;

Gäumannomyces graminis in cereals and lawns; Helminthosporium species in maize, rice and potatoes; Hemileia vastatrix on coffee; Microdochium species in wheat and rye; Mycosphaerella fijiensis in banana; Phakopsora species in soybeans, such as Phakopsora pachyrizi in soybeans; Puccinia species in cereals, broadleaf crops and perennial plants; such as Puccinia recondita on wheat, Puccinia striiformis on wheat and Puccinia recondita on barley; Pseudocercosporella species in cereals, such as Pseudocercosporella herpotrichoides in wheat; Phragmidium mucronatum in roses; Podosphaera species in fruits;

Pyrenophora species in barley, such as Pyrenophora teres on barley; Pyricularia oryzae in rice; Ramularia collo-cygni in barley; Rhizoctonia species in cotton, soybean, cereals, maize, potatoes, rice and lawns, such as Rhizoctonia solani on potato, rice, turf and cotton; Rhynchosporium secalis on barley, Rhynchosporium secalis on rye; Sclerotinia species in lawns, lettuce, vegetables and oil seed rape, such as Sclerotinia sclerotiorum on oilseed rape and Sclerotinia homeocarpa on turf; Septoria species in cereals, soybean and vegetables, such as Septoria tritici on wheat, Septoria nodorum on wheat and Septoria glycines on soybean; Sphacelotheca reilliana in maize; Tilletia species in cereals; Uncinula necator, Guignardia bidwellii and Phomopsis viticola in vines; Urocystis occulta in rye; Uromyces species in beans; Ustilago species in cereals and maize; Venturia species in fruits, such as Venturia inequalis on apple; Monilinia species on fruits; Penicillium species on citrus and apples.

For example, the mixtures and compositions of the invention are useful for controlling oomycete pathogens, in particular
Downy mildew (e.g. Plasmopora viticola, Bremia lactucae, Peronospora parasitica, Peronospora destructor, Pseudoperonospora cubensis).
Phytophthora blight (Phytophthora capsici),
Late blight (Phytophthora infestans),
Blue Mold (Peronospora effuse) e.g. on the following crops:
   Brassica vegetables (e.g. Broccoli, Brussels sprouts, Cabbage, Cauliflower, Collards, Kale); Mustard greens (e.g. head and stem subgroup—Cavalo broccolo, Chinese broccoli, Chinese cabbage, Chinese mustard cabbage and kohlrabi)(leafy greens subgroup—broccoli raab, Chinese cabbage, mizuna, mustard spinach, rape greens);
   Bulb vegetables (e.g. Dry bulb (garlic, bulb onion, shallot);
   Green onion (e.g. leek, green onions, Welch onion);
   Cucurbit vegetables (e.g. Cantaloupe, Chayote, Chinese waxgourd, Cucumber, Gourds, Honeydew, Momordica spp. (bitter melon and balsam apple), Muskmelon, Pumpkin, Squash, Watermelon, Zucchini);

### Grapes;

Leafy vegetables (e.g. Amaranth, Arugula, Cardoon, Celery (Chinese), Celtuce, Chervil, Chrysanthemum (edible-leaved and garland), Corn saladCress (garden and upland), Dandelion, Dock, Endive, Fennel (Florence), Orach, Parsley, Purslane (garden and winter), Radicchio (red chicory), Rhubarb, Lettuce (leaf and head), Spinach (New Zealand and vine), Swiss chard);
Peppers (bell pepper, non-bell pepper, sweet non-bell pepper).

The mixtures and compositions of the invention are particularly useful for control of fungal disease on potatoes, e.g. late blight (Phytophthora infestans), pink rot (Phytophthora erythoseptica). In particular, mixtures of mandipropamid and fluopicolide with one or more of chlorothalonil, mancozeb, and mefenoxam, or other labelled product with activity against Phytophthora are advantageous for use on potatoes, e.g. to control development of pathogen resistance.

The mixtures and compositions of the invention are particularly useful for control of fungal disease on vegetables, e.g. Downy mildew (e.g., Peronospora parasitica, Peronospora destructor, Pseudoperonospora cubensis, Bremia lactucae, etc.), Pythium spp, Phytophthora spp. (e.g., Phytophthora capsici, Phytophthora infestans, etc.), Blue Mould (Peronospora effusa) In particular, mixtures of mandipropamid and fluopicolide with one or more of chlorothalonil, mancozeb, and mefenoxam, or other labelled product with activity against Phytophthora are advantageous for use on vegetables, e.g. to control development of pathogen resistance.

Suitable vegetables include:

Brassica Vegetables: Broccoli; Chinese broccoli (gai Ion); Brussels sprouts; Cabbage; Chinese cabbage (napa); Chinese mustard cabbage (gai choy); Cauliflower; Cavalo broccoli; Kohlrabi. Broccoli rabb; Chinese cabbage; Collards; Kale; Mizuna; Mustard greens; Mustard spinach; Rape greens. Bulb Vegetables: Onion, bulb, Garlic, Shallot, Green Onion Green onions; Leek; Welch onion. Cucurbits: Cantaloupe; Chayote; Chinese-waxgourd; Field cucumber; Gourds; Honeydew Melons; Momordica spp. (bitter melon, balsam apple); Muskmelon; Watermelon; Pumpkin; Squash; Zucchini. Peppers: Field pepper transplants; For use on peppers to be treated in the greenhouse and immediately transplanted to the field. Bell peppers, Non-bell peppers, Sweet non-bell peppers. Tomatoes: Field Tomato, Tomatillo, Greenhouse Tomatoes (e.g. for use in greenhouse only—not for transplant to the field). Leafy Vegetables: Field lettuce, leaf and head lettuce. Spinach. Greenhouse Lettuce (e.g. for use in greenhouse only—not for transplant to the field).

The mixtures and compositions of the invention are particularly useful for control of fungal disease on grapes and fruits, e.g. Downy mildew (e.g. Plasmopora viticola). In particular, mixtures of mandipropamid and fluopicolide with one or more of chlorothalonil, mancozeb, and mefenoxam, or other labelled product with activity against Phytophthora are advantageous for use on grapes and fruits, e.g. to control development of pathogen resistance.

The mixtures and compositions of the invention are particularly useful for control of fungal disease such as Pythium Blight, Pythium Damp-Off on turf, e.g. golf courses, sod farms, home and garden. Turf may be established or over-seeded. In particular, mixtures of mandipropamid and fluopicolide optionally with one or more of chlorothalonil, mancozeb, and mefenoxam, or other labelled product with activity against Phytophthora, are advantageous for use on turf, e.g. to control development of pathogen resistance. Likewise, mixtures of metalaxyl-M and fluopicolide are advantageous for use on turf.

The mixtures and compositions of the invention are particularly useful for seed treatment (“seed care”). In particular mixtures of mandipropamid and fluopicolide according to the invention, e.g. optionally with one or more of chlorothalonil, mancozeb, and mefenoxam, or other labelled product with activity against Phytophthora are advantageous for use with seed care, e.g. to control development of pathogen resistance. Suitable crop seeds include any crop listed herein, including wheat, barley, rye, triticale, oats, etc., maize, soybeans, sorghum, peas, lentils, chickpeas, dry edible beans, cotton. Such seed treatment may be for control of Clubroot of Canola, and other Brassica crops, “Plasmodiophora brassicae Woronin”, Pythium, Damping off. Likewise, mixtures of metalaxyl-M and fluopicolide according to the invention are advantageous for use with seed care.

The mixtures and compositions of the invention are also effective on Canola; Oilseed Rape, Cereals (e.g. wheat, barley, oats, rye) Corn, Soybeans, Pulse Crops (e.g., Lentils, Chickpeas, Field Peas, Dry Edible Beans), Sunflower, Turf, ornamental plants such as roses, Greenhouse Ornamentals, Greenhouse peppers; Greenhouse lettuce; Greenhouse cucumbers.

In general, the weight ratio of component (A) to component (B) is from 2000:1 to 1:2000, e.g. 2000:1 to 1:1000. For example, the weight ratio of (A):(B) from 200:1 to 1:5; e.g. from 20:1 to 2:1, e.g. from 15:1 to 3:1.

The amount of combination of the invention to be applied, will depend on various factors such as the compound employed, the subject of the treatment (plant, soil, seed), the type of treatment (e.g. spraying, dusting, seed dressing), the purpose of the treatment (prophylactic or therapeutic), the type of fungi to be treated, the infection pressure which in turn is depending on concentration and fitness of infecting spores or conidia, and the application time, relative to the seasonal and short term climatic conditions influencing the maturity status of the phytopathogenic fungus.

The method of the invention comprises applying to the treated plants or the locus thereof in admixture or separately, a fungicidally effective aggregate amount of component (A) and component (B).

The invention also provides a pesticidal mixtures and compositions comprising an additional component (C) selected from the group consisting of a fungicide, an insecticide, a bactericide and a plant-bioregulator. In particular, the mixtures and compositions of the invention, also include mixtures and compositions comprising a further pesticide listed below. For example, a mixture or composition comprising mandipropamid and fluopicolide or metalaxyl-M and fluopicolide may comprise a further pesticide selected from the group consisting of:

a fungicide such as
(C1) a strobilurin fungicide, (C2) an azole fungicide, (C3) a morpholine fungicide, (C4) an anilinopyrimidine fungicide, (C5) a fungicide selected from the group consisting of anilazine (878), arsenates, benalaxyl (56), benalaxyl-M, benodanil (896), benomyl (62), benthiavalicarb, benthiavalicarb-isopropyl (68), biphenyl (81), bitertanol (84), blasticidin-S (85), bordeaux mixture (87), boscalid (88), bupirimate (98), cadmium chloride, captafol (113), captan (114), carbendazim (116), carbon disulfide (945), carboxin (120), carpropamid (122), cedar leaf oil, chinomethionat (126), chlorine, chloroneb (139), chlorothalonil (142), chlozolinate (149), cinnamaldehyde, copper, copper ammoniumcarbonate, copper hydroxide (169), copper octanoate (170), copper oleate, copper sulphate (87), cyazofamid (185), cycloheximide (1022), cymoxanil (200), dichlofluanid (230), dichlone (1052), dichloropropene (233), diclocymet (237), diclomezine (239), dicloran (240), diethofencarb (245), diflumetorim (253), dimethirimol (1082), dimethomorph (263), dinocap (270), dithianon (279), dodine (289), edifenphos (290), ethaboxam (304), ethirimol (1133), etridiazole (321), famoxadone (322), fenamidone (325), fenaminosulf (1144), fenamiphos (326), fenarimol (327), fenfuram (333), fenhexamid (334), fenoxanil (338), fenpiclonil (341), fentin acetate (347), fentin chloride, fentin hydroxide (347), ferbam (350), ferimzone (351), fluazinam (363), fludioxonil (368), flusulfamide (394), flutolanil (396), folpet (400), formaldehyde (404), fosetyl-aluminium (407), fthalide (643), fuberidazole (419), furalaxyl (410), furametpyr (411), flyodin (1205), fuazatine (422), hexachlorobenzene (434), hymexazole, iminoctadine (459), iodocarb (3-Iodo-2-propynyl butyl carbamate), iprobenfos (IBP) (469), iprodione (470), iprovalicarb (471), isoprothiolane (474), kasugamycin (483), mancozeb (496), maneb (497), manganous dimethyldithiocarbamate, mefenoxam (Metalaxyl-M) (517), mepronil (510), mercuric chloride (511), mercury, metalaxyl (516), methasulfocarb (528), metiram (546), metrafenone, nabam (566), neem oil (hydrophobic extract), nuarimol (587), octhilinone (590), ofurace (592), oxadixyl (601), oxine copper (605), oxolinic acid (606), oxycarboxin (608), oxytetracycline (611), paclobutrazole (612), paraffin oil (628), paraformaldehyde, pencycuron (620), pentachloronitrobenzene (716), pentachlorophenol (623), penthiopyrad, perfurazoate, phosphoric acid, polyoxin (654), polyoxin D zinc salt (654), potassium bicarbonate, probenazole (658), procymidone (660), propamocarb (668), propineb (676), proquinazid (682), prothiocarb (1361), pyrazophos (693), pyrifenox (703), pyroquilon (710), quinoxyfen (715), quintozene (PCNB) (716), silthiofam (729), sodium bicarbonate, sodium diacetate, sodium propionate, streptomycin (744), sulphur (754), TCMTB, tecloftalam, tecnazene (TCNB) (767), thiabendazole (790), thifluzamide (796), thiophanate (1435), thiophanate-methyl (802), thiram (804), tolclofos-methyl (808), tolylfluanid (810), triazoxide (821), trichoderma harzianum (825), tricyclazole (828), triforine (838), triphenyltin hydroxide (347), validamycin (846), vinclozolin (849), zineb (855), ziram (856), zoxamide (857), 1,1-bis(4-chlorophenyl)-2-ethoxyethanol (IUPAC-Name) (910), 2,4-dichlorophenyl benzenesulfonate (IUPAC-/Chemical Abstracts-Name) (1059), 2-fluoro-N-methyl-N-1-naphthylacetamide (IUPAC-Name) (1295), 4-chlorophenyl phenyl sulfone (IUPAC-Name) (981),
a compound of formula C-5.1

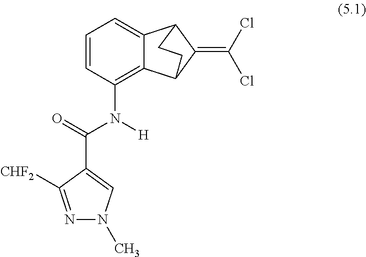

a compound of formula C-5.2

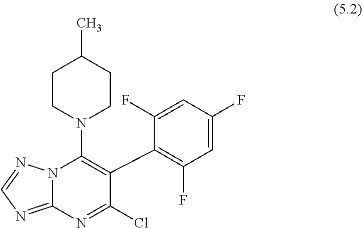

a compound of formula C-5.3

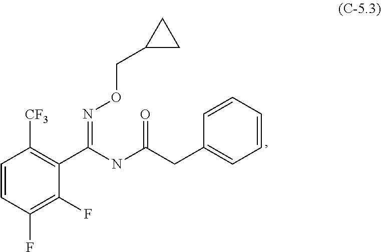

a compound of formula C-5.4

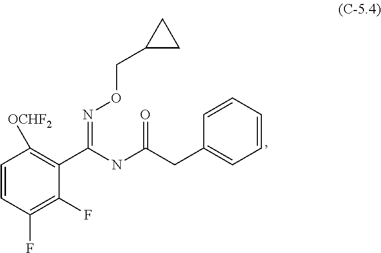

a compound of formula C-5.5

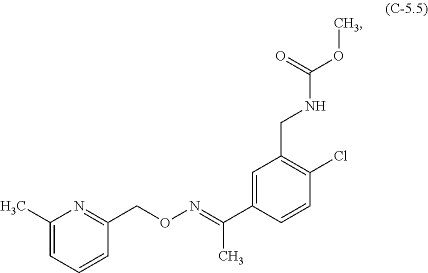

a compound of formula C-5.6

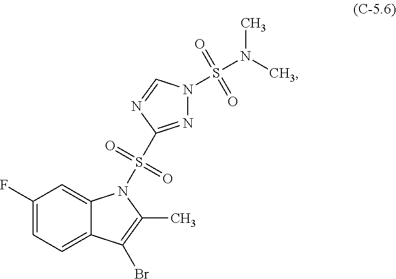

3-difluoromethyl-1-methyl-1H-pyrazole-4-carboxylic acid (2-bicyclopropyl-2-yl-phenyl)-amide (compound C-5.8), 3-difluoromethyl-1-methyl-1H-pyrazole-4-carboxylic acid (9-isopropyp-1,2,3,4-tetrahydro-1,4-methano-naphthalen-5-yl)-amide (compound C-5.9), 1,3-dimethyl-5-fluoro-1H-pyrazole-4-carboxylic acid [2-(1,3-dimethylbutyl)phenyl]-amide (compound C-5.10), 3-difluoromethyl-1-methyl-1H-pyrazole-4-carboxylic acid (3′,4′-dichloro-5-fluoro-1,1′-biphenyl-2-yl)-amide (compound C-5.11), N-{2-[3-chloro-5-(trifluoromethyl)pyridin-2-yl]ethyl}-2-(trifluoromethyl)benzamid (compound C-5.12), 3-difluoromethyl-1-methyl-1H-pyrazole-4-carboxylic acid N-[2-(1,1,2,2-tetrafluoroethoxy)phenyl]-amide (compound C-5.13), 3-difluoromethyl-1-methyl-1H-pyrazole-4-carboxylic acid N-[2-(1,1,2,3,3,3-hexafluoropropoxy)phenyl]-amide (compound C-5.14), 3-difluoromethyl-1-methyl-1H-pyrazole-4-carboxylic acid N-[2-(2-chloro-1,1,2-trifluoroethoxy)phenyl]-amide (compound C-5.15), 3-difluoromethyl-1-methyl-1H-pyrazole-4-carboxylic acid N-(4′-trifluoromethyl-biphen-2-yl)-amide (compound C-5.16), 3-difluoromethyl-1-methyl-1H-pyrazole-4-carboxylic acid N-(2′-trifluoromethyl-biphen-2-yl)-amide (compound C-5.17) and 3-difluoromethyl-1-methyl-1H-pyrazole-4-carboxylic acid N-(2′-trifluoromethyl-biphen-2-yl)-amide (compound C-5.18);
a plant-bioregulator selected from the group consisting of
acibenzolar-S-methyl (6), chlormequat chloride (137), ethephon (307), mepiquat chloride (509) and trinexapac-ethyl (841);
an insecticide selected from the group consisting of
abamectin (1), emamectin benzoate (291), tefluthrin (769), a compound of formula C-7.1

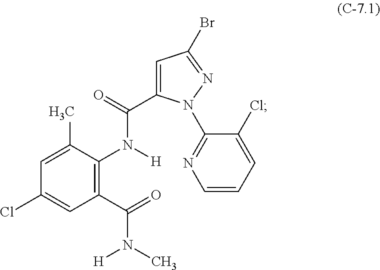

and a compound of formula C-7.2;

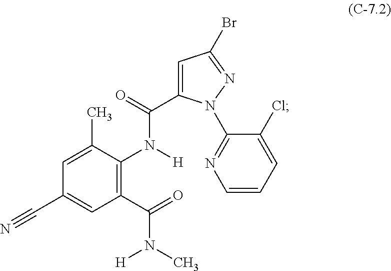

as well as glyphosate (419).

For example, when component (A) is mandipropamid, component (C) may be an active ingredient selected from the group consisting of

a fungicide selected from mancozeb, chlorothalonil, metalaxyl-M, metalaxyl, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil;
a bactericide selected from oxidised copper and oxidised silver; and acibenzolar-S-methyl.

In particular, when component (A) is mandipropamid, component (C) may be selected from mancozeb, mefenoxam, chlorothalonil, metalaxyl-M, metalaxyl, and ametoctradin. For example, when component (A) is metalaxyl-M, component (C) may be an active ingredient selected from the group consisting of

a fungicide selected from mancozeb, chlorothalonil, mandipropamid, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil;
a bactericide selected from oxidised copper and oxidised silver; and acibenzolar-S-methyl.

In particular, when component A is metalaxyl-M, component (C) may be selected from mancozeb, mefenoxam, chlorothalonil and ametoctradin.

Compositions of the invention preferably include mandipropamid and fluopicolide or metalxyl-M and fluopicolide but, e.g. do not include clothianidin, imidacloprid or thiamethoxam. Compositions of the invention may also include one or more of chlorothalonil, mancozeb, and mefenoxam, or other labelled product with activity against Phytophthora.

Thus, compositions of the invention include:

manipropamid+fluopicolide+mancozeb;
manipropamid+fluopicolide+chlorothalonil;
manipropamid+fluopicolide+mefenoxam;
manipropamid+fluopicolide+metalaxyl-M;
manipropamid+fluopicolide+metalaxyl;
manipropamid+fluopicolide+ametoctradin;
manipropamid+fluopicolide+azoxystrobin;
manipropamid+fluopicolide+acibenzolar-S-methyl;
manipropamid+fluopicolide+fludioxinil;
manipropamid+fluopicolide+difenoconazole;
manipropamid+fluopicolide+prothioconazole;
manipropamid+fluopicolide+triadimenol;
manipropamid+fluopicolide+tefluthrin;
manipropamid+fluopicolide+fipronil;
manipropamid+fluopicolide+oxidised copper;
manipropamid+fluopicolide+oxidised silver;
manipropamid+fluopicolide+amisulbrom;
manipropamid+fluopicolide+cyazofamid;
manipropamid+fluopicolide+flusulfamide;
manipropamid+fluopicolide+pymetrozine;
manipropamid+fluopicolide+lambda cyhalothrin;
metalaxyl-M+fluopicolide+mancozeb;
metalaxyl-M+fluopicolide+mefenoxam;
metalaxyl-M+fluopicolide+chlorothalonil;
metalaxyl-M+fluopicolide+ametoctradin;
metalaxyl-M+fluopicolide+azoxystrobin;
metalaxyl-M+fluopicolide+acibenzolar-S-methyl;
metalaxyl-M+fluopicolide+fludioxinil;
metalaxyl-M+fluopicolide+difenoconazole;
metalaxyl-M+fluopicolide+prothioconazole;
metalaxyl-M+fluopicolide+triadimenol;
metalaxyl-M+fluopicolide+tefluthrin;
metalaxyl-M+fluopicolide+fipronil;
metalaxyl-M+fluopicolide+oxidised copper;
metalaxyl-M+fluopicolide+oxidised silver;
metalaxyl-M+fluopicolide+amisulbrom;
metalaxyl-M+fluopicolide+cyazofamid;
metalaxyl-M+fluopicolide+flusulfamide;
metalaxyl-M+fluopicolide+pymetrozine; and
metalaxyl-M+fluopicolide+lambda cyhalothrin.

The components (C) are known. Where the components (C) are included in “The Pesticide Manual” [The Pesticide Manual—A World Compendium; Thirteenth Edition; Editor: C. D. S. Tomlin; The British Crop Protection Council], they are in most cases described therein under the entry number given in round brackets hereinabove for the particular component (B); for example, the compound “abamectin” is described under entry number (1). Most of the components (C) are referred to hereinabove by a so-called “common name”, the relevant “ISO common name” or another “common name” being used in individual cases. If the designation is not a “common name”, the nature of the designation used instead is given in round brackets for the particular component (C); in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed. Ametoctradin is being commercialised under the trade name Intium®.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides the actual synergistic action with respect to fungicidal activity, the mixtures and compositions according to the invention can also have further surprising advantageous properties. Examples of such advantageous properties that may be mentioned are: more advantageous degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some mixtures and compositions according to the invention have a systemic action and can be used as foliar, soil and seed treatment fungicides.

With the mixtures and compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The mixtures and compositions according to the invention can be applied to the phytopathogenic microorganisms, the useful plants, the locus thereof, and the propagation material thereof, storage goods or technical materials threatened by microorganism attack.

The mixtures and compositions according to the invention may be applied before or after infection of the useful plants, the propagation material thereof, storage goods or technical materials by the microorganisms.

The amount of a composition according to the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi to be controlled or the application time.

When applied to the useful plants component (A) is typically applied at a rate of 5 to 2000 g a.i./ha, particularly 10 to 1000 g a.i./ha, e.g. 50, 75, 100 or 200 g a.i./ha, typically in association with 1 to 5000 g a.i./ha, particularly 2 to 2000 g a.i./ha, e.g. 100, 250, 500, 800, 1000, 1500 g a.i./ha of component (B).

In agricultural practice the application rates of the compositions according to the invention depend on the type of effect desired, and typically range from 20 to 4000 g of total composition per hectare.

When the mixtures and compositions according to the invention are used for treating seed, rates of 0.001 to 50 g of a compound of component (A) per kg of seed, preferably from 0.01 to 10 g per kg of seed, and 0.001 to 50 g of a compound of component (B), per kg of seed, preferably from 0.01 to 10 g per kg of seed, are generally sufficient.

The mixtures and composition of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such mixtures and compositions may be produced in conventional manner, e.g. by mixing the active ingredients with at least one appropriate inert formulation adjuvant (for example, diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

Customary formulation ingredients are, for example, formulation ingredients that are do not have any significant biological activity, or have no biological activity. They include, for example, diluents, solvents, fillers, surfactants, biocides, anti-freeze, stickers, thickeners and compounds that provide adjuvancy effects.

The compositions according to the invention may also comprise further pesticides, such as, for example, fungicides, insecticides or herbicides.

A seed dressing formulation is applied in a manner known per se to the seeds employing the compositions according to the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least a compound of component (A) together with a compound of component (B), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

The Examples which follow serve to illustrate the invention, “active ingredient” denoting a mixture of component (A) and component (B) in a specific mixing ratio. The invention is not limited to these Examples.

### Formulation Examples

| Wettable powders | a) | b) | c) |
|---|---|---|---|
| active ingredient [(A):(B) = 8:1(a), 5:1(b), 3:1(c)] | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| kaolin | 62% | 27% | — |

The active ingredient is thoroughly mixed with the adjuvants and the mixture is thoroughly ground in a suitable mill, affording wettable powders which can be diluted with water to give suspensions of the desired concentration.

Emulsifiable concentrate

| | |
|---|---|
| active ingredient ((A):(B)) = 6:1) | 10% |
| octylphenol polyethylene glycol ether (4-5 mol of ethylene oxide) | 3% |
| calcium dodecylbenzenesulfonate | 3% |
| castor oil polyglycol ether (35 mol of ethylene oxide) | 4% |
| cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| active ingredient [(A):(B) = 7:1(a), 10:1(b), 1:1(c)] | 5% | 6% | 4% |
| talcum | 95% | — | — |
| kaolin | — | 94% | — |
| mineral filler | — | — | 96% |

Ready-for-use dusts are obtained by mixing the active ingredient with the carrier and grinding the mixture in a suitable mill. Such powders can also be used for dry dressings for seed.

| Extruded granules | a) | b) |
|---|---|---|
| active ingredient ((A):(B) = 2:1) | 15% | 25% |
| sodium lignosulfonate | 2% | 3% |
| carboxymethylcellulose | 1% | 1% |
| kaolin | 82% | 71% |

The active ingredient is mixed and ground with the adjuvants, and the mixture is moistened with water. The mixture is extruded and then dried in a stream of air.

| Coated granules | |
|---|---|
| active ingredient ((A):(B) = 120:1) | 8% |
| polyethylene glycol (mol. wt. 200) | 3% |
| kaolin | 89% |

The finely ground active ingredient is uniformly applied, in a mixer, to the kaolin moistened with polyethylene glycol. Non-dusty coated granules are obtained in this manner.

Suspension concentrate

| | |
|---|---|
| active ingredient ((A):(B) = 4:1) | 40% |
| propylene glycol | 10% |
| nonylphenol polyethylene glycol ether (15 mol of ethylene oxide) | 6% |
| sodium lignosulfonate | 10% |
| carboxymethylcellulose | 1% |
| silicone oil (in the form of a 75% emulsion in water) | 1% |
| water | 32% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow Release Capsule Suspension

28 parts of a combination of component (A) and component (B), or of each of these components separately, are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

### EXAMPLES

### Example 1

### Evaluation of Different Rates of Presidio® (Fluopicolide), Revus® (Mandipropamid) and Ridomil Gold SL® (Metalaxyl-M) for Control of Downy Mildew (B. lactucae) on Lettuce

This study was conducted to determine the range of fungicide rates needed to allow for the detection of possible synergistic interactions between the products. Presidio was tested at 0.3, 1 and 3 mg a.i./L; Revus® was tested at 0.01, 0.1 and 1 mg a.i./L; and Ridomil Gold SL® was tested at 0.3, 1 and 3 mg a.i./L. The rationale for selecting low rates of the fungicides was to have incomplete control of the disease and, therefore, be able to detect any synergistic interactions from mixtures. The disease severity levels with the fungicide concentrations selected were found to give appropriate levels of control and further studies were planned based on these concentrations, with the exception of the Revus® concentration of 1 mg a.i./L that provided too high a level of control of the disease (Table 1). Therefore, a lower concentration of Revus® (0.3 mg a.i./L) was selected for further studies.

TABLE 1
Evaluation of different rates of Presidio ®, Revus ® and
Ridomil Gold ® on the reduction of downy mildew caused by
B. lactucae on lettuce.

| | Concentration | |
|---|---|---|
| Fungicide | (mg a.i./L) | Disease (%)^{ab} |
| Presidio ® | 0.3 | 100.0 |
| Presidio ® | 1 | 85.1 |
| Presidio ® | 3 | 59.7 |
| Revus ® | 0.01 | 100.0 |
| Revus ® | 0.1 | 94.3 |
| Revus ® | 1 | 12.2 |
| Ridomil ® | 0.3 | 83.7 |
| Ridomil ® | 1 | 70.8 |
| Ridomil ® | 3 | 61.7 |

^{a}Mean of 3 replicates
^{b}% disease relative to check (unsprayed plants)

### Example 2

### Evaluation of Mixtures of Presidio® and Revus® for Control of Downy Mildew (B. lactucae) on Lettuce

Presidio® at 0.3 and 1 mg a.i./L and Revus® at 0.1 and 0.3 mg a.i./L were tested alone and in combination for control of downy mildew caused by B. Lactucae. Plants were inoculated 24 h after the fungicide application with a sporangial suspension at a concentration of 1×10⁴ sporangia/ml of water and spraying the inoculum on the lower and upper surfaces of leaves. At 8 days after inoculation disease severity was measured as % leaf area infected. Synergy between Presidio® and Revus® was not detected when Presidio® at 0.3 mg. a.i./L was combined with Revus® either at 0.1 or 0.3 mg a.i./L (Table 2). However, good synergistic interactions were detected when Presidio at a rate of 1 mg a.i./L was combined with Revus® at 0.1 or 0.3 mg a.i./L (Table 3).

TABLE 2
Effect of mixtures of Presidio ® and Revus ® on % disease
inhibition caused by B. lactucae

| | Concentration | % disease^{ab} | % disease^{c} |
|---|---|---|---|
| Fungicide | (mg a.i./L) | observed | expected |
| Presidio ® | 0.3 | 94.5 | — |
| Presidio ® | 1 | 90.8 | — |
| Revus ® | 0.1 | 42.6 | — |
| Revus ® | 0.3 | 36.1 | — |
| Presidio ® + | 0.3 + 0.1 | 52.4 | 40.3 |
| Revus ® | | | |
| Presidio ® + | 0.3 + 0.3 | 32.9 | 34.2 |
| Revus ® | | | |
| Presidio ® + | 1 + 0.1 | 15.7 | 38.7 |
| Revus ® | | | |
| Presidio ® + | 1 + 0.3 | 22.7 | 32.8 |
| Revus ® | | | |

^{a}Mean of 3 replications
^{b}% disease relative to check (unsprayed plants)
^{c}% disease expected from fungicide combination

### Example 3

### Evaluation of Mixtures of Presidio® and Revus® for Control of Downy Mildew (B. lactucae) on Lettuce—Second Study

A second study was conducted again looking at the synergistic interaction of Presidio® and Revus® on the control of lettuce downy mildew in order to validate the results obtained in the first study. As in the previous study, sporangia of B. Lactucae were inoculated one day after fungicide application. In this study, Presidio® was tested at 1, 3 and 10 mg a.i./L and Revus® at 0.03, 0.1 and 0.3 mg a.i./L alone and in combination. The inoculum concentration was higher in this study, with 2×10⁴ sporangia/ml inoculated on the lower and upper surfaces of the leaves. Eight days after inoculation, disease severity was measured as % leaf area infected. Disease severity was higher in this study compared to the previous one. The results of the first study were validated since good synergistic interactions between Presidio® and Revus® were detected in all combinations tested in the second study (Table 3).

TABLE 3
Effect of mixtures of Presidio ® and Revus ® on % disease
inhibition caused by B. lactucae

| | Concentration | % disease^{ab} | % disease^{c} |
|---|---|---|---|
| Fungicide | mg a.i./L | observed | expected |
| Presidio ® | 1 | 100.0 | — |
| Presidio ® | 3 | 97.3 | — |
| Presidio ® | 10 | 41.8 | — |
| Revus ® | 0.03 | 100.0 | — |
| Revus ® | 0.1 | 70.9 | — |
| Revus ® | 0.3 | 45.5 | — |
| Presidio ® + | 1 + 0.03 | 75.1 | 100.0 |
| Revus ® | | | |
| Presidio ® + | 1 + 0.1 | 41.8 | 70.9 |
| Revus ® | | | |
| Presidio ® + | 1 + 0.3 | 37.0 | 45.5 |
| Revus ® | | | |
| Presidio ® + | 3 + 0.03 | 61.9 | 97.3 |
| Revus ® | | | |
| Presidio ® + | 3 + 0.1 | 39.1 | 68.9 |
| Revus ® | | | |
| Presidio ® + | 3 + 0.3 | 25.9 | 44.2 |
| Revus ® | | | |
| Presidio ® + | 10 + 0.03 | 16.4 | 41.8 |
| Revus ® | | | |
| Presidio ® + | 10 + 0.1 | 12.7 | 29.6 |
| Revus ® | | | |
| Presidio ® + | 10 + 0.3 | 5.8 | 19.0 |
| Revus ® | | | |

^{a}Mean of 3 replications
^{b}% disease relative to check (unsprayed plants)
^{c}% disease expected from fungicide combination

### Example 4

### Evaluation of Mixtures of Presidio® and Ridomil Gold SL® for Control of Downy Mildew (B. lactucae) on Lettuce

Presidio® at 0.3 and 1 mg a.i./L and Ridomil Gold SL® at 0.1 and 0.3 mg a.i./L were tested alone and in combination for control of lettuce downy mildew. Lettuce treated with fungicides or untreated were inoculated one day of application with a sporangial suspension adjusted to 1×10⁴ sporangia/ml. Disease severity ratings were conducted 8 days after inoculation and measured as % leaf area infected. All the combinations of Presidio® and Ridomil Gold SL® exhibited clear synergistic interactions (Table 4).

TABLE 4
Effect of mixtures of Presidio ® and -Ridomil Gold
SL ® on % disease inhibition caused by B. lactucae

| | Concentration | % disease^{ab} | % disease^{c} |
|---|---|---|---|
| Fungicide | (mg a.i./L) | observed | expected |
| Presidio ® | 0.3 | 94.5 | — |
| Presidio ® | 1 | 90.8 | — |
| Ridomil ® | 0.1 | 100.0 | — |
| Ridomil ® | 0.3 | 75.0 | — |
| Presidio ® + | 0.3 + 0.3 | 38.4 | 98.5 |
| Ridomil ® | | | |
| Presidio ® + | 0.3 + 1 | 50.7 | 70.9 |
| Ridomil ® | | | |
| Presidio ® + | 1 + 0.3 | 51.4 | 90.8 |
| Ridomil ® | | | |
| Presidio ® + | 1 + 1 | 38.4 | 68.1 |
| Ridomil ® | | | |

^{a}Mean of 3 replications
^{b}% disease relative to check (unsprayed plants)
^{c}% disease expected from fungicide combination

### Example 5

### Evaluation of Mixtures of Presidio® and Ridomil Gold SL® for Control of Downy Mildew (B. lactucae) on Lettuce—Second Study

In this second study, Presidio at 1 and 3 mg a.i./L and Ridomil at 0.3, 1 and 3 mg a.i./L were tested alone and in combination for control of lettuce downy mildew. Lettuce treated with fungicides or untreated were inoculated one day of application with a sporangial suspension adjusted to 2×10⁴ sporangia/ml. The inoculum concentration was higher in this study compared to the first one. Disease severity ratings were conducted 8 days after inoculation and measured as % leaf area infected. Once again, all the combinations of Presidio and Ridomil Gold SL exhibited clear synergistic interactions (Table 5).

TABLE 5
Effect of mixtures of Presidio ® and Ridomil Gold SL ® on
% disease inhibition caused by B. lactucae

| | Concentration | % disease^{ab} | % disease^{c} |
|---|---|---|---|
| Fungicide | (mg a.i./L) | observed | expected |
| Presidio ® | 1 | 95.2 | — |
| Presidio ® | 3 | 61.2 | — |
| Ridomil ® | 0.3 | 96.0 | — |
| Ridomil ® | 1 | 84.9 | — |
| Ridomil ® | 3 | 78.6 | — |
| Presidio ® + | 1 + 0.3 | 83.9 | 91.4 |
| Ridomil ® | | | |
| Presidio ® + | 1 + 1 | 67.9 | 80.8 |
| Ridomil ® | | | |
| Presidio ® + | 1 + 3 | 38.9 | 74.8 |
| Ridomil ® | | | |
| Presidio ® + | 3 + 0.3 | 20.1 | 58.7 |
| Ridomil ® | | | |
| Presidio ® + | 3 + 1 | 6.7 | 51.9 |
| Ridomil ® | | | |
| Presidio ® + | 3 + 3 | 3.6 | 48.1 |
| Ridomil ® | | | |

^{a}Mean of 3 replications
^{b}% disease relative to check (unsprayed plants)
^{c}% disease expected from fungicide combination

1. A pesticidal mixture comprising a component (A) and a component (B), wherein components (A) and (B) are:
(A) a carboxylic acid amide fungicide; and
(B) a benzamide fungicide; with the proviso that the mixture does not comprise:
1. fluopicolide and mandipropamid and clothianidin; or
2. fluopicolide and mandipropamid and imidacloprid; or
3. fluopicolide and mandipropamid and thiamethoxam.

2. A pesticidal mixture according to claim 1, wherein component (A) is selected from the group consisting of: an N-alkoxycarbonyl-alpha-amino acid amide derivative of formula III, or an optical isomer thereof 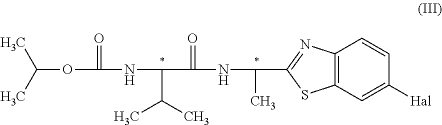
in which Hal is fluoro, chloro or bromo;
an N-alkylsulfonyl-alpha-amino acid amide derivative of formula IV, or an optical isomer thereof 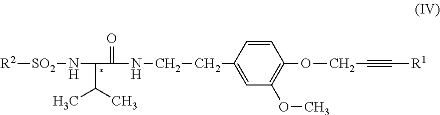
in which R¹ is hydrogen, Ci.C₄alkyl, C₃₋C₆cycloalkyl or halophenyl; and R² is Ci.C₄alkyl;
an alpha-alkynyloxyphenylacetic acid amide derivative of formula V, or an optical isomer thereof (V) 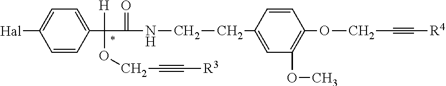
in which Hal is fluoro, chloro or bromo; R³ is hydrogen, Ci.C₄alkyl or halophenyl; and R⁴ is hydrogen, Ci.C₄alkyl, C₃-C₆cycloalkyl or halophenyl;
dimethomorph;
flumorph;
benthiavalicarb;
iprovalicarb; and
valifenalate.

3. A pesticidal mixture according to claim 1, wherein component (A) is selected from the group consisting of:
mandipropamid;
dimethomorph;
flumorph;
benthiavalicarb;
iprovalicarb; and
valifenalate.

4. A pesticidal mixture according to claim 1, wherein component (B) is selected from the group consisting of a compound of formula (X) 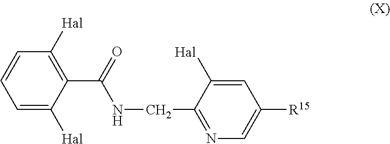
in which Hal is fluoro, chloro or bromo, R¹⁵ is CH₂F, CF₂ or CF₃; and
zoxamide.

5. A pesticidal mixture according to claim 1, wherein component (A) is selected from the group consisting of
mandipropamid;
dimethomorph;
flumorph;
benthiavalicarb;
iprovalicarb; and
valifenalate;
and component (B) is fluopicolide.

6. A pesticidal mixture according to claim 1, wherein component (A) is mandipropamid and component (B) is fluopicolide.

7. A pesticidal mixture according to claim 1, wherein the weight ratio of (A) to (B) is from 2000:1 to 1:2000.

8. A pesticidal mixture according to claim 1, wherein the mixture comprises an additional component (C) selected from the group consisting of a fungicide, an insecticide, a bactericide and a plant-bioregulator.

9. A pesticidal mixture according to claim 1, wherein the composition comprises an additional component (C) selected from the group consisting of
a fungicide selected from mancozeb, chlorothalonil, metalaxyl-M, metalaxyl, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1; an insecticide selected from tefluthrin, pymetrozine, lambda cyhalothrin and fipronil; a bactericide selected from oxidised copper, high valency silver; and acibenzolar-S-methyl.

10. A composition for controlling fungal diseases caused by phytopathogens comprising a pesticidal mixture as defined in claim 1.

11. A composition comprising as active ingredients
(A) mandipropamid,
(B) fluopicolide, and optionally
(C) an active ingredient selected from the group consisting of a fungicide, an insecticide, a bactericide and a plant-bioregulator, wherein the insecticide is not thiamethoxam, imidacloprid or clothianidin; and customary formulation ingredients.

12. A composition according to claim 11, comprising as active ingredients
(A) mandipropamid,
(B) fluopicolide, and optionally
(C) an active ingredient selected from the group consisting of a fungicide selected from mancozeb, chlorothalonil, metalaxyl-M, metalaxyl, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1; an insecticide selected from tefluthrin, pymetrozine, lambda cyhalothrin and fipronil; a bactericide selected from oxidised copper and oxidised silver; and
acibenzolar-S-methyl; and customary formulation ingredients.

13. A method of controlling diseases on useful plants or on propagation material thereof caused by phytophathogens, which comprises applying to the useful plants, the locus thereof or propagation material thereof a pesticidal mixture or composition as defined in claim 1.

14. A seed comprising a composition or mixture as defined in claim 1.

15. A method comprising coating a seed with a pesticidal mixture or composition as defined in claim 1.

16. A pesticidal mixture comprising a component (A) and a component (B), wherein components (A) and (B) are:
(A) metalaxyl-M; and
(B) a benzamide fungicide;
with the proviso that the mixture does not comprise:
1. fluopicolide and metalaxyl-M and clothianidin; or
2. fluopicolide and metalaxyl-M and imidacloprid; or
3. fluopicolide and metalaxyl-M and thiamethoxam.

17. A pesticidal mixture according to claim 16, wherein component B is selected from the group consisting of a compound of formula (X) 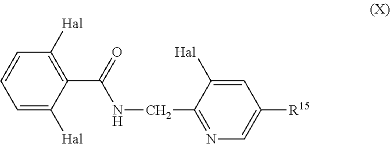
in which Hal is fluoro, chloro or bromo, R¹⁵ is CH₂F, CF₂ or CF₃; and
zoxamide.

18. A pesticidal mixture according to claim 16, wherein component (B) is fluopicolide.

19. A pesticidal mixture according to claim 16, wherein the weight ratio of (A) to (B) is from 2000:1 to 1:2000.

20. A pesticidal mixture according to claim 16, wherein the mixture comprises an additional component (C) selected from the group consisting of a fungicide, an insecticide, a bactericide and a plant-bioregulator, wherein the insecticide is not thiamethoxam, imidacloprid or clothianidin.

21. A pesticidal mixture according to claim 16, wherein the composition comprises an additional component (C) selected from the group consisting of
(A) metalaxyl-M,
(B) fluopicolide, and optionally
(C) an active ingredient selected from the group consisting of a fungicide selected from mancozeb, chlorothalonil, mandipropamid, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1;
an insecticide selected from tefluthrin, pymetrozine, lambda cyhalothrin and fipronil; a bactericide selected from oxidised copper and oxidised silver; and acibenzolar-S-methyl.

22. A composition for controlling fungal diseases caused by phytopathogens comprising a mixture as defined in claim 16.

23. A composition comprising as active ingredients
(A) metalaxyl-M,
(B) fluopicolide, and optionally
(C) an active ingredient selected from the group consisting of a fungicide, an insecticide and a bactericide, wherein the insecticide is not thiamethoxam, imidacloprid or clothianidin; and customary formulation ingredients.

24. A composition according to claim 23, comprising as active ingredients
(A) metalaxyl-M,
(B) fluopicolide, and optionally
(C) an active ingredient selected from the group consisting of
a fungicide selected from mancozeb, chlorothalonil, mandipropamid, ametoctradin, azoxystrobin, isopyrazam, fludioxinil, difenoconazole, prothioconazole, triadimenol, cyproconazole, sedaxane, cyprodinil, penconazole, propiconazole, pyraclostrobin, boscalid, bixafen, fluopyram, penthiopyrad, thiabendazole, fluazinam, fenpropidin, cyflufenamid, tebuconazole, trifloxystrobin, fluxapyroxad, penflufen, fluoxastrobin, kresoxim-methyl, benthiavalicarb, dimethomorph, amisulbrom, cyazofamid, flusulfamide and a compound of formula C-5.1; an insecticide selected from tefluthrin, pymetrozine, lambda cyhalothrin and fipronil; a bactericide selected from oxidised copper and oxidised silver; and acibenzolar-S-methyl; and customary formulation ingredients.

25. A method of controlling diseases on useful plants or on propagation material thereof caused by phytophathogens, which comprises applying to the useful plants, the locus thereof or propagation material thereof a pesticidal mixture or composition as defined in claim 16.

26. A method of controlling pythium on plant propagation material comprising applying a mixture or composition as defined in claim 16 to the plant propagation material.

27. A method according to claim 26, wherein the plant propagation material is corn, soybean, wheat, barley, cotton or canola.

28. A seed comprising a pesticidal mixture or composition as defined in claim 16.

29. A method comprising coating a seed with a composition as defined in claim 16.
